(19) United States
(12) Patent Application Publication
(10) Pub. No.: US 2025/0113825 A1
(43) Pub. Date: Apr. 10, 2025

(54) FUNGICIDAL COMBINATIONS AND METHODS FOR CONTROLLING PHYTOPATHOGENIC FUNGI

(71) Applicants: UPL CORPORATION LIMITED, Port Louis (MU); UPL EUROPE LTD, Warrington (GB)

(72) Inventors: Biswajit CHOWDHURI, Mumbai (IN); Jean Mary ZONATO, São Paulo (BR); Ronaldo Bueno RODRIGUES, São Paulo (BR)

(21) Appl. No.: 18/729,576

(22) PCT Filed: Jan. 17, 2023
(86) PCT No.: PCT/GB2023/050074

§ 371 Date: Jul. 17, 2024

(30) Foreign Application Priority Data
Jan. 19, 2022 (IN) 202221003093

(51) Int. Cl. A01N 43/653; A01N 37/10; A01N 43/16; A01N 43/28; A01N 43/40; A01N 43/42; A01N 43/54; A01N 59/20; A01P 3/00

(52) U.S. Cl. CPC A01N 43/653; A01N 37/10; A01N 43/16; A01N 43/28; A01N 43/40; A01N 43/42; A01N 43/54; A01N 59/20; A01P 3/00

(57) ABSTRACT

The present invention relates to fungicidal combinations and compositions comprising said combinations for controlling phytopathogenic fungi causing rice blast diseases. The present invention also relates to a method for controlling or preventing Magnaporthe grisea causing rice blast diseases.

### TECHNICAL FIELD

The present invention relates to fungicidal combinations for controlling phytopathogenic fungi and compositions comprising said combinations. The present invention also relates to a method for controlling or preventing phytopathogenic fungi by applying said combinations or compositions. More particularly, the present invention relates to a method for controlling infestation by phytopathogenic fungi in rice cultivations.

### BACKGROUND OF THE INVENTION

The protection of plants against diseases which cause great and irreparable loss, damage, harm, and injury to plants is essential for healthy growing of the plant and enhancing the quality of agricultural produce. Most crops and agricultural produce are subject to attack by several fungi. Fungal infestations cause significant yield reduction, therefore, preventing and treating fungal infestation in plants and plant parts is crucial to obtain high productivity and is a continual objective in the agricultural field.

Fungicides are a specific class of agrochemicals that are used widely to control fungal diseases by inhibiting or killing fungi causing diseases. Up to now, several active compounds having controlled effect against various plant diseases have been found, and various controlling agents for plant diseases, comprising them as active ingredients have been developed. 1,2,4-triazole and its derivative compounds represent one of the most biologically active classes of compounds, possessing a wide spectrum of activities. 1,2,4-triazole fungicides exhibit their antifungal activity by inhibiting C14-demethylase (P450 enzyme), a well-known target for fungicides. 1,2,4-triazoles are economically important agrochemicals as they are widely used on crops such as wheat, barley, soybean and orchard fruits. A triazole fungicide of particular importance is 2-[2-(1-chlorocyclopropyl)-3-(2-chlorophen-yl)-2-hydroxypropyl]-2,4-dihydro-[1,2,4-]-triazole-3-thione, i.e. prothioconazole. Prothioconazole is a sterol demethylation inhibitor (DMI) compound and is used in agriculture as a fungicide.

Rice (Oryza sativa) is a crucial staple food crop in the world; accordingly, its supply must double by 2050 to keep up with food demand from population growth. One of the largest impediments to increased rice production is the presence of rice blast (Magnaporthe oryzae fungus), which directly decreases rice yields and indirectly increases production costs. Mostly Rhizoctonia solani (teleomorph: Thanatephorus cucumeris), Magnaporthe grisea (anamorph: Pyricularia oryzae), Helminthosporium oryzae (syn: Drechslera oryzae), Xanthomonas oryzae pv. Oryza, Sclerotium oryzae or Sarocladium oryzae cause rice diseases that are difficult to control. The most destructive disease of rice is rice blast, which is caused by a heterothallic ascomycetous pathogen, Pyricularia oryzae. The disease causes symptoms on leaves, stems, nodes, roots, and panicles of rice, leading to severe yield loss.

Rice blast (Magnaporthe oryzae) is a key concern in achieving global food security given the disease is responsible for approximately 30% of rice production losses globally which is the equivalent of feeding 60 million people. These losses are likely to increase the global rice price and reduce consumer welfare and food security. Yield loss from blast infections depends on varietal susceptibility, the degree of infection, and the timing of fungicide application. Some yield losses associated with blast outbreaks have reached 50% or more, and the cost of mitigating those blast outbreaks via fungicide application. An outbreak of rice blast sometimes takes place in abnormal weather conditions such as low temperature or sudden rain in the summer period, thus, rice blast is one of the most serious rice diseases world-wide and development of new control strategies for blast disease are urgently required.

Moreover, an ever-increasing global demand for rice, particularly in Asia, coupled with unpredictable weather calamities in the last few years has added immense stress on rice farmers in the region. This has necessitated farmers to find new ways to grow better quality of rice in a manner that is efficient and sustainable.

WO 97/40683 discloses a composition of propiconazole and tricyclazole suitable for treating rice against infestation by Pyricularia species and Rhizoctonia species. However, the performance of the said combination against the said fungal rice pathogens is still not completely satisfactory in all respects. Accordingly, a need exists for agents which control fungal pathogens on rice plants more efficiently. There is a need for blast alleviation in rice cultivation to increase global food security and to lower losses from blast.

Therefore, it is an object of the present invention to provide fungicide combinations having an improved and/or increased fungicidal activity and/or a broader activity spectrum against phytopathogenic fungi when applied to rice plants or cultivations.

It is another object of the present invention for controlling or preventing phytopathogenic fungi, more particularly rice blast diseases causing fungi in rice. The present invention is particularly useful for controlling noxious fungal diseases in rice, i.e. rice blast caused by Magnaporthe oryzae.

### DESCRIPTION OF INVENTION

For the purposes of the following detailed description, it is to be understood that the invention may assume various alternative variations, except where expressly specified to the contrary.

Moreover, other than in any operating examples, or where otherwise indicated, all numbers expressing, for example, quantities of materials/ingredients used in the specification are to be understood as being modified in all instances by the term “about”.

The term “about” used to qualify the amounts of active components shall be interpreted to mean “approximately” or “reasonably close to” and any statistically insignificant variations therefrom.

As used herein, the terms “comprising” “including,” “having,” “containing,” “involving,” and the like are to be understood to be open-ended, to mean including but not limited to.

In any aspect or embodiment described hereinbelow, the phrase comprising may be replaced by the phrases “consisting of” or “consisting essentially of”. In these aspects or embodiments, the combinations or compositions described includes or comprises or consists of or consists essentially of or consists substantially of the specific components recited therein, to the exclusion of other ingredients or excipients not specifically recited therein.

The phrase ‘fungicidally effective amount of the fungicide’ refers to an amount of the fungicide that kills or inhibits the phytopathogenic disease for which control is desired, in an amount not significantly toxic to the plant being treated.

The term ‘disease control’ as used herein denotes control and prevention of a disease specified herein. Controlling effects include all deviation from natural development, for example: killing, retardation, inhibition or decrease of the fugal disease.

The term ‘phytotoxicity’ refers to a toxic (negative) effect on the growth of a plant.

The term ‘plants’ refer to all physical parts of a plant, including seeds, seedlings, saplings, roots, tubers, stems, propagule, stalks, foliage and fruits.

“Fungicidal” refers to the ability of a substance to decrease or inhibit growth of fungi.

To “control” or “controlling” fungus means to inhibit, and/or suppress the ability of fungus to grow and/or reproduce, or to limit fungus damage or loss in crop plants or denotes control and prevention of a disease. Controlling effects include all deviation from natural development, for example: killing, retardation, decrease of the disease.

The term “locus” as used herein shall denote the vicinity of a desired crop in which control of the spread of phytopathogenic fungi is desired. The locus includes the vicinity of desired crop plants wherein the phytopathogenic fungi infection has either emerged or is most likely to emerge or is yet to emerge.

The term ‘plant propagation material’ is understood to denote generative parts of a plant, such as seeds, vegetative material such as cuttings or tubers, roots, fruits, bulbs, rhizomes and parts of plants, germinated plants and young plants which are to be transplanted after germination or after emergence from the soil. These young plants may be protected before transplantation by a total or partial treatment by immersion.

The term ‘agriculturally acceptable amount of active’ refers to an amount of an active that kills or inhibits the plant disease for which control is desired, in an amount not significantly toxic to the plant being treated.

As used herein, the term ‘% disease severity’ refers to the percentage decay observed in the crop in terms of the percentage of relevant host tissues covered by lesions or damaged by the disease. Severity results from the number and size of the lesions. The % severity indicates the extent of damage caused by the disease.

As used therein, the term ‘% disease control’ refers to the % control and prevention of a target disease in crop.

The term “g ai/L” as used herein denotes the concentration of the respective active ingredient in “grams” present “per litre” of the composition.

The term “g ai/h” as used herein denotes the concentration of the respective active ingredient in “grams” applied “per hectare” of the crop field.

Each of the aspects described above may have one or more embodiments.

Each of the embodiments described hereinafter may apply to one or all aspects described hereinabove. These embodiments are intended to be read as being preferred features of one or all aspects described hereinabove. Each of the embodiments described hereinafter applies to each of the aspects described hereinabove individually.

The present invention relates to a fungicidal combination, a composition comprising the same and method for controlling fungal infestation in crops.

The present inventors have surprisingly found that the fungicide combinations comprising a demethylation inhibitor fungicide, particularly prothioconazole shows excellent fungicidal activity against Pyricularia oryzae in rice plants as compared to untreated plants with no phytotoxicity. The present inventors have unexpectedly found that fungicide combinations comprising a demethylation inhibitor fungicide and one more fungicide showed superior efficacy accompanied with synergistic activity in the control of blast diseases in rice cultivations, particularly rice leaf blast and rice neck blast. More particularly, the present inventors have found that the combination comprising prothioconazole and at least one strobilurin fungicide show synergistic activity in control of blast diseases in rice. Further combinations comprising prothioconazole and a 4-quinolyl acetate fungicide, i.e., tebufloquin, prothioconazole and a dithiolane, i.e., isoprothiolane, prothioconazole and kasugamycin and prothioconazole and sulphur showed efficient control of leaf blast and neck blast diseases caused by Magnaporthe grisea.

Accordingly, the present invention provides in various embodiments, combinations, compositions, use, methods for controlling, preventing, or partially preventing Pyricularia oryzae infestation, or a symptom or a condition associated with Pyricularia oryzae infestation in rice by applying prothioconazole or combinations thereof to the affected or unaffected rice plant.

The present invention provides fungicide combinations comprising a demethylation inhibitor fungicide and at least one fungicide for controlling phytopathogenic fungi in rice cultivations.

In an embodiment, the present invention provides fungicide combinations comprising a demethylation inhibitor fungicide and at least one fungicide for controlling phytopathogenic fungi in rice cultivations, particularly fungi causing neck blast and leaf blast in rice.

Accordingly, the present invention provides fungicide combinations comprising a demethylation inhibitor (DMI) fungicide and at least one fungicide for preventing or controlling phytopathogenic fungi in rice, particularly fungi belonging to Pyricularia sp.

The present invention thus relates to fungicide combinations comprising a demethylation inhibitor fungicide, particularly a triazole compound (I) and at least one second/another fungicide compound (II) as described herein for controlling phytopathogenic fungi of Pyricularia oryzae in rice.

In an embodiment, the present invention provides a fungicidal combination for controlling blast diseases in rice, the combination comprising: (i) a demethylation inhibitor fungicide, and (ii) at least one fungicide.

In an embodiment, the demethylation inhibitor fungicide is a triazole fungicide.

In an embodiment, the present invention provides a fungicidal combination for controlling blast diseases in rice, said combination comprising: (i) a triazole fungicide, and (ii) at least one fungicide.

According to an embodiment, the triazole fungicide (I) is selected from the group comprising azaconazole, bromuconazole, cyproconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, thiabendazole, triadimefon, triadimenol, triticonazole, uniconazole and uniconazole-P, their salts, or esters, or isomers or derivatives thereof or combinations thereof.

According to a preferred embodiment, the triazole compound (I) is 2-[2-(chlorocyclopropyl)-3-(2-chlorophen-yl)-2-hydroxypropyl]-2,4-dihydro-[1,2,4-]-triazole-3-thione (prothioconazole) or salts, or esters, metabolites, or isomers or derivatives thereof.

In an embodiment, the present fungicide combination comprises prothioconazole as compound (I).

Accordingly, numerical references of (i) and (I) assigned to the demethylation inhibitor fungicide, or to the triazole compound or to prothioconazole are deemed to designate the said fungicide as the first fungicide of the fungicide combination.

In an embodiment, the fungicide combinations comprise prothioconazole and at least another fungicide compound (II) as described herein for controlling phytopathogenic fungi Pyricularia oryzae in rice.

Accordingly, numerical references of (ii) and (II) referring to the second fungicide in the fungicidal combination are deemed to designate the said fungicides as the second fungicide of the fungicide combination.

In an embodiment, the second fungicide compound (II) in combination with said triazole fungicide compound (I) is selected from the group comprising contact fungicides, an inorganic compound, dithiocarbamate fungicides, quinone outside inhibitor (QoI), succinate dehydrogenase inhibitor (SDHI), quinone inside inhibitor (QiI), 4-quinolyl acetate, hexopyranosyl antibiotic, and dithiolane or combinations thereof.

In a further embodiment, the second fungicide is a demethylation inhibitor fungicide.

In an embodiment, the second fungicide is a quinone outside inhibitor fungicide.

In another embodiment, the quinone outside inhibitor is selected from strobilurin fungicides. According to an embodiment, the strobilurin fungicide is selected from the group comprising azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone or pyribencarb.

According to one preferred embodiment, the strobilurin fungicide comprises azoxystrobin, picoxystrobin, pyraclostrobin, fluoxastrobin and trifloxystrobin.

In another embodiment, the succinate dehydrogenase inhibitor (SDHI) is selected from the group comprising benzovindiflupyr, bixafen, fluxapyroxad, furametpyr, isopyrazam, penflufen, penthiopyrad, sedaxane, boscalid, thifluzamide, carboxin, oxycarboxin, fenfuram, fluopyram, isofetamid, benodanil, flutolanil or mepronil.

In an embodiment, the contact fungicide is a multi-site fungicide selected from inorganic compounds, dithiocarbamates, phthalimides, chloronitriles, sulfamides, bis-guanidines, triazines, quinones, quinoxalines, maleimides and thiocarbamates.

In an embodiment, the contact fungicide comprises amobam, asomate, azithiram, carbamorph, cufraneb, cuprobam, disulfiram, ferbam, metam, nabam, tecoram, thiram, urbacide, ziram, dazomet, etem, milneb, copper sulphate, dibasic copper sulphate, tribasic copper sulphate, copper oxychloride, sulphur, mancopper, mancozeb, maneb, metiram, polycarbamate, propineb or zineb.

In a preferred embodiment, the dithiocarbamate fungicide is mancozeb.

In a preferred embodiment, the inorganic compound is a copper salt.

In a preferred embodiment, the copper salt is tribasic copper sulphate.

In a preferred embodiment, the copper salt is copper oxychloride.

In a preferred embodiment, the inorganic compound is sulphur.

In a preferred embodiment, the inorganic compound is sulphur or its salts.

In an embodiment, the quinone inside inhibitor (QII) is selected from the group comprising cyazofamid, amisulbrom, fenpicoxamide and florylpicoxamid.

In an embodiment, the second fungicide is a 4-quinolyl acetate fungicide.

In another embodiment, the 4-quinolyl acetate fungicide is tebufloquin.

In an embodiment, the second fungicide is a hexopyranosyl antibiotic.

In another embodiment, the hexopyranosyl antibiotic is kasugamycin.

In an embodiment, the second fungicide is a dithiolane.

In an embodiment, the dithiolane fungicide is isoprothiolane.

In an embodiment, the second fungicide is a systemic fungicide comprising nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inducers, fungicides with unknown modes of action, fungicide with no classification, or biologicals with multiple mode of action.

In some embodiments, the fungicide is combined with a triazole compound (I) selected from the group comprising metrafenone, amisulbrom, isotianil, fluopicolide, fenpyrazamine, valifenalate, mandipropamid, penflufen, bixafen, fluopyram, fluxapyroxad, isopyrazam, penthiopyrad, pyriofenone, sedaxane, pydiflumetofen, dichlobentiazox, isoflucypram, fenpicoxamid, florylpicoxamid, fluoxapiprolin, mefentrifluconazole, ipfentrifluconazole, metyltetraprole, inpyrfluxam, quinofumelin, oxathiapiprolin, fluindapyr, dipymetitrone, pyridachlometyl, benzovindiflupyr, orysastrobin, ametoctradin, flutianil, pyraziflumid, coumoxystrobin, pyribencarb, tebufloquin, isofetamid, tolprocarb, mandestrobin and picarbutrazox.

In an embodiment, the fungicidal combination for controlling rice blast comprises;
(i) prothioconazole, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof.

In an embodiment, the fungicidal combination for controlling rice blast comprises;
(i) prothioconazole, and
(ii) a quinone outside inhibitor (QoI) fungicide comprising a strobilurin fungicide.

In an embodiment, the present invention provides a fungicidal combination for controlling rice blast comprising:
(i) prothioconazole; and
(ii) at least one strobilurin fungicide.

In an embodiment, the present invention provides a fungicidal combination for controlling rice blast, the fungicidal combination comprising:
(i) prothioconazole; and
(ii) azoxystrobin.

In an embodiment, the present invention provides a fungicidal combination for controlling rice blast, the fungicidal combination comprising:
(i) prothioconazole; and
(ii) picoxystrobin.

In an embodiment, the present invention provides a fungicidal combination for controlling rice blast, the fungicidal combination comprising:
(i) prothioconazole; and
(ii) trifloxystrobin.

In an embodiment, the present invention provides a fungicidal combination for controlling rice blast, the fungicidal combination comprising:
(i) prothioconazole; and
(ii) fluoxastrobin.

In an embodiment the present invention provides a fungicidal combination for controlling rice blast, the fungicidal combination comprising:
(i) prothioconazole; and
(ii) tebufloquin.

In an embodiment the present invention provides a fungicidal combination for controlling rice blast, the fungicidal combination comprising:
(i) prothioconazole; and
(ii) kasugamycin.

In an embodiment the present invention provides a fungicidal combination for controlling rice blast, the fungicidal combination comprising:
(i) prothioconazole; and
(ii) isoprothiolane.

In an embodiment the present invention provides a fungicidal combination for controlling rice blast, the fungicidal combination comprising:
(i) prothioconazole; and
(ii) an inorganic compound.

In an embodiment the present invention provides a fungicidal combination for controlling rice blast, the fungicidal combination comprising prothioconazole and a copper salt.

In an embodiment the present invention provides a fungicidal combination for controlling rice blast, the fungicidal combination comprising:
(i) prothioconazole; and
(ii) a copper salt comprising copper oxychloride, copper sulphate, tribasic copper sulphate and such other salts of copper.

In an embodiment the present invention provides a fungicidal combination for controlling rice blast, the fungicidal combination comprising:
(i) prothioconazole; and
(ii) sulphur or its salts.

As used throughout the disclosure, the active ingredient, include their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

The weight ratio of active compounds used in present fungicide combinations is usually from about 500:1 to about 1:500, preferably from 100:1 to 1:100, more preferably from 50:1 to 1:50, and most preferably from 25:1 to 1:25.

In an embodiment, the fungicidal combination comprises a demethylation inhibitor fungicide and one more fungicide in a ratio ranging from 1:15 to 15:1.

In an embodiment, the fungicidal combination comprises a demethylation inhibitor fungicide and one more fungicide in a ratio ranging from 1:10 to 10:1.

In an embodiment, the fungicidal combination comprises a demethylation inhibitor fungicide and one more fungicide in a ratio ranging from 1:5 to 5:1.

In an embodiment, the fungicidal combination comprises a triazole fungicide and one more fungicide in a ratio ranging from 1:15 to 15:1.

In an embodiment, the fungicidal combination comprises a triazole fungicide and one more fungicide in a ratio ranging from 1:10 to 10:1.

In an embodiment, the fungicidal combination comprises a triazole fungicide and one more fungicide in a ratio ranging from 1:5 to 5:1.

In an embodiment, the fungicidal combination comprises prothioconazole and one more fungicide in a ratio ranging from 1:15 to 15:1.

In an embodiment, the fungicidal combination comprises prothioconazole and one more fungicide in a ratio ranging from 1:10 to 10:1.

In an embodiment, the fungicidal combination comprises prothioconazole and one more fungicide in a ratio ranging from 1:5 to 5:1.

In an embodiment, the present invention provides a fungicidal combination for controlling rice blast diseases in rice crop comprising:
(i) a demethylation inhibitor fungicide, and
(ii) at least one fungicide;
   wherein the demethylation inhibitor fungicide and the second fungicide are in a ratio ranging from 1:15 to 15:1.

In an embodiment, the present invention provides a fungicidal combination for controlling rice blast diseases in rice crop comprising:
(i) a triazole fungicide, and
(ii) at least one fungicide;
   wherein the triazole fungicide and the second fungicide are in a ratio ranging from 1:15 to 15:1.

In an embodiment, the present invention provides a fungicidal combination for controlling rice blast diseases in rice crop comprising:
(i) a triazole fungicide, and
(ii) at least one fungicide;
   wherein the triazole fungicide and the second fungicide are in a ratio ranging from 1:10 to 10:1.

In an embodiment, the present invention provides a fungicidal combination for controlling rice blast diseases in rice crop comprising;
(i) a triazole fungicide comprising prothioconazole, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, an inorganic compound, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides a fungicidal combination for controlling rice blast diseases in rice crop comprising;
(i) prothioconazole, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof;
   wherein prothioconazole and the second fungicide are in a ratio ranging from 1:10 to 10:1.

In an embodiment, the present invention provides a fungicidal combination for controlling rice blast diseases in rice crop comprising:
(i) a triazole fungicide, and
(ii) at least a Quinone outside inhibitor (QoI) fungicide;
   wherein the triazole fungicide and the Quinone outside inhibitor (QoI) fungicide are in a ratio ranging from 1:15 to 15:1.

In an embodiment, the present invention provides a fungicidal combination for controlling rice blast diseases in rice crop comprising:
(i) a triazole fungicide, and
(ii) at least a Quinone outside inhibitor (QoI) fungicide;
   wherein the triazole fungicide and the Quinone outside inhibitor (QoI) fungicide are in a ratio ranging from 1:10 to 10:1.

In an embodiment, the present invention provides a fungicidal combination for controlling rice blast diseases in rice crop comprising:
(i) prothioconazole, and
(ii) at least a Quinone outside inhibitor (QoI) fungicide comprising a strobilurin fungicide;
   wherein prothioconazole and the Quinone outside inhibitor (QoI) fungicide are in a ratio ranging from 1:15 to 15:1.

In an embodiment, the present invention provides a fungicidal combination for controlling rice blast diseases in rice crop comprising:
(i) prothioconazole, and
(ii) at least a Quinone outside inhibitor (QoI) fungicide comprising a strobilurin fungicide;
   wherein prothioconazole and the Quinone outside inhibitor (QoI) fungicide are in a ratio ranging from 1:10 to 10:1.

In an embodiment, the present invention provides a fungicidal combination for controlling rice blast diseases in rice crop comprising:
(i) prothioconazole; and
(ii) at least one strobilurin fungicide;
   wherein prothioconazole and the strobilurin fungicide are in a ratio ranging from 1:15 to 15:1.

In an embodiment, the present invention provides a fungicidal combination for controlling rice blast diseases in rice crop comprising:
(i) prothioconazole; and
(ii) at least one strobilurin fungicide;
   wherein prothioconazole and the strobilurin fungicide are in a ratio ranging from 1:10 to 10:1.

In an embodiment, the present invention provides a fungicidal combination for controlling rice blast diseases in rice crop, the fungicidal combination comprising:
(i) prothioconazole; and
(ii) azoxystrobin;
   wherein prothioconazole and azoxystrobin are in a ratio ranging from 1:15 to 15:1.

In an embodiment, the present invention provides a fungicidal combination for controlling rice blast diseases in rice crop, the fungicidal combination comprising:
(i) prothioconazole; and
(ii) azoxystrobin;
   wherein prothioconazole and azoxystrobin are in a ratio ranging from 1:10 to 10:1.

In an embodiment, the present invention provides a fungicidal combination for controlling rice blast diseases in rice crop, the fungicidal combination comprising:
(i) prothioconazole; and
(ii) picoxystrobin;
   wherein prothioconazole and picoxystrobin are in a ratio ranging from 1:15 to 15:1.

In an embodiment, the present invention provides a fungicidal combination for controlling rice blast diseases in rice crop, the fungicidal combination comprising:
(i) prothioconazole; and
(ii) picoxystrobin;
   wherein prothioconazole and picoxystrobin are in a ratio ranging from 1:10 to 10:1.

In an embodiment, the present invention provides a fungicidal combination for controlling rice blast diseases in rice crop, the fungicidal combination comprising:
(i) prothioconazole; and
(ii) trifloxystrobin;
   wherein prothioconazole and trifloxystrobin are in a ratio ranging from 1:15 to 15:1.

In an embodiment, the present invention provides a fungicidal combination for controlling rice blast diseases in rice crop, the fungicidal combination comprising:
(i) prothioconazole; and
(ii) trifloxystrobin;
   wherein prothioconazole and trifloxystrobin are in a ratio ranging from 1:10 to 10:1.

In an embodiment, the present invention provides a fungicidal combination for controlling rice blast diseases in rice crop, the fungicidal combination comprising:
(i) prothioconazole; and
(ii) fluoxastrobin;
   wherein prothioconazole and fluoxastrobin are in a ratio ranging from 1:15 to 15:1.

In an embodiment, the present invention provides a fungicidal combination for controlling rice blast diseases in rice crop, the fungicidal combination comprising:
(i) prothioconazole; and
(ii) fluoxastrobin;
   wherein prothioconazole and fluoxastrobin are in a ratio ranging from 1:10 to 10:1.

In an embodiment the present invention provides a fungicidal combination for controlling rice blast diseases in rice crop, the fungicidal combination comprising:
(i) prothioconazole; and
(ii) a 4-quinolyl acetate fungicide
   wherein prothioconazole and a 4-quinolyl acetate fungicide are in a ratio ranging from 1:15 to 15:1.

In an embodiment the present invention provides a fungicidal combination for controlling rice blast diseases in rice crop, the fungicidal combination comprising:
(i) prothioconazole; and
(ii) tebufloquin;
   wherein prothioconazole and tebufloquin are in a ratio ranging from 1:15 to 15:1.

In an embodiment the present invention provides a fungicidal combination for controlling rice blast diseases in rice crop, the fungicidal combination comprising:
(i) prothioconazole; and
(ii) tebufloquin;
   wherein prothioconazole and tebufloquin are in a ratio ranging from 1:10 to 10:1.

In an embodiment the present invention provides a fungicidal combination for controlling rice blast diseases in rice crop, the fungicidal combination comprising:
(i) prothioconazole; and
(ii) kasugamycin;
   wherein prothioconazole and kasugamycin are in a ratio ranging from 1:15 to 15:1.

In an embodiment the present invention provides a fungicidal combination for controlling rice blast diseases in rice crop, the fungicidal combination comprising:
(i) prothioconazole; and
(ii) kasugamycin;
   wherein prothioconazole and kasugamycin are in a ratio ranging from 1:10 to 10:1.

In an embodiment the present invention provides a fungicidal combination for controlling rice blast diseases in rice crop, the fungicidal combination comprising:
(i) prothioconazole; and
(ii) a dithiolane fungicide,
   wherein prothioconazole and the dithiolane fungicide are in a ratio ranging from 1:15 to 15:1.

In an embodiment the present invention provides a fungicidal combination for controlling rice blast diseases in rice crop, the fungicidal combination comprising:
(i) prothioconazole; and
(ii) isoprothiolane;
   wherein prothioconazole and isoprothiolane are in a ratio ranging from 1:15 to 15:1.

In an embodiment the present invention provides a fungicidal combination for controlling rice blast diseases in rice crop, the fungicidal combination comprising:
(i) prothioconazole; and
(ii) isoprothiolane;
   wherein prothioconazole and isoprothiolane are in a ratio ranging from 1:10 to 10:1.

In an embodiment the present invention provides a fungicidal combination for controlling rice blast diseases in rice crop, the fungicidal combination comprising:
(i) prothioconazole; and
(ii) an inorganic compound,
   wherein prothioconazole and an inorganic compound are in a ratio ranging from 1:15 to 15:1.

In an embodiment the present invention provides a fungicidal combination for controlling rice blast diseases in rice crop, the fungicidal combination comprising:
(i) prothioconazole; and
(ii) an inorganic compound,
   wherein prothioconazole and an inorganic compound are in a ratio ranging from 1:10 to 10:1.

In an embodiment the present invention provides a fungicidal combination for controlling rice blast diseases in rice crop, the fungicidal combination comprising:
(i) prothioconazole; and
(ii) sulphur,
   wherein prothioconazole and sulphur are in a ratio ranging from 1:15 to 15:1.

In an embodiment the present invention provides a fungicidal combination for controlling rice blast diseases in rice crop, the fungicidal combination comprising:
(i) prothioconazole; and
(ii) sulphur
   wherein prothioconazole and sulphur are in a ratio ranging from 1:10 to 10:1.

According to the present invention references to rice blast diseases refers to crop diseases caused in rice cultivations by the blast fungus Magnaporthe oryzae (syn. Pyricularia oryzae), inflicting serious damage to rice leaves (leaf blast) and panicles (panicle or neck blast). Moreover, all parts of the panicle—spikelet, glume, branches, rachis, and neck—are susceptible to blast disease; in particular, damage to the neck (neck blast) leads to complete loss of the panicle

In an embodiment, the present invention provides a fungicidal combination for controlling rice blast fungi, Magnaporthe grisea in rice cultivations, the combination comprising:
(i) a triazole fungicide, and
(ii) at least one fungicide;
   wherein the triazole fungicide and the second fungicide are in a ratio ranging from 1:15 to 15:1.

In an embodiment, the present invention provides a fungicidal combination for controlling rice blast fungi, Magnaporthe grisea in rice cultivations, the combination comprising:
(i) a triazole fungicide comprising prothioconazole, and
(ii) a second fungicide selected from the group comprising a quinone outside inhibitor (QoI) fungicide, an inorganic compound, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole, and
(ii) at least a Quinone outside inhibitor (QoI) fungicide comprising a strobilurin fungicide;
   wherein prothioconazole and the Quinone outside inhibitor (QoI) fungicide are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) azoxystrobin;
   wherein prothioconazole and azoxystrobin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) picoxystrobin;
   wherein prothioconazole and picoxystrobin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) trifloxystrobin;
   wherein prothioconazole and trifloxystrobin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) fluoxastrobin;
   wherein prothioconazole and fluoxastrobin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) tebufloquin;
   wherein prothioconazole and tebufloquin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) kasugamycin;
   wherein prothioconazole and kasugamycin are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) isoprothiolane;
   wherein prothioconazole and isoprothiolane are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) an inorganic compound,
   wherein prothioconazole and isoprothiolane are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) sulphur
   wherein prothioconazole and isoprothiolane are in a ratio ranging from 1:15 to 15:1.

In an embodiment, the present invention provides a fungicidal combination for controlling rice blast fungi, Magnaporthe grisea in rice cultivations, the combination comprising:
(i) prothioconazole; and
(ii) copper salt
   wherein prothioconazole and isoprothiolane are in a ratio ranging from 1:15 to 15:1.

In an embodiment, the present invention provides a fungicidal combination for controlling rice blast diseases in rice crop comprising:
(i) a demethylation inhibitor fungicide in an amount ranging from 50 to 500 g/ha; and
(ii) at least one fungicide in an amount ranging from 10 to 300 g/ha.

In an embodiment, the present invention provides a fungicidal combination for controlling rice blast diseases in rice crop comprising:
(i) a triazole fungicide in an amount ranging from 50 to 500 g/ha; and
(ii) at least one fungicide in an amount ranging from 10 to 300 g/ha.

In an embodiment, the present invention provides a fungicidal combination for controlling rice blast diseases in rice crop comprising:
(i) prothioconazole in an amount ranging from 50 to 500 g/ha; and
(ii) at least one fungicide in an amount ranging from 10 to 300 g/ha.

In an embodiment, the present invention provides a fungicidal combination for controlling rice blast diseases in rice crop comprising:
(i) prothioconazole in an amount ranging from 50 to 500 g/ha; and
(ii) at least one strobilurin fungicide in an amount ranging from 10 to 300 g/ha.

In an embodiment, the present invention provides a fungicidal combination for controlling rice blast diseases in rice crop, the fungicidal combination comprising:
(i) prothioconazole in an amount ranging from 50 to 500 g/ha; and
(ii) azoxystrobin in an amount ranging from 10 to 300 g/ha.

In an embodiment, the present invention provides a fungicidal combination for controlling rice blast diseases in rice crop, the fungicidal combination comprising:
(i) prothioconazole in an amount ranging from 50 to 500 g/ha; and
(ii) picoxystrobin in an amount ranging from 10 to 300 g/ha.

In an embodiment, the present invention provides a fungicidal combination for controlling rice blast diseases in rice crop, the fungicidal combination comprising:
(i) prothioconazole in an amount ranging from 50 to 500 g/ha; and
(ii) trifloxystrobin in an amount ranging from 10 to 300 g/ha.

In an embodiment, the present invention provides a fungicidal combination for controlling rice blast diseases in rice crop, the fungicidal combination comprising:
(i) prothioconazole in an amount ranging from 50 to 500 g/ha; and
(ii) fluoxastrobin in an amount ranging from 10 to 300 g/ha.

In an embodiment the present invention provides a fungicidal combination for controlling rice blast diseases in rice crop, the fungicidal combination comprising:
(i) prothioconazole in an amount ranging from 50 to 500 g/ha; and
(ii) tebufloquin in an amount ranging from 10 to 300 g/ha.

In an embodiment the present invention provides a fungicidal combination for controlling rice blast diseases in rice crop, the fungicidal combination comprising:
(i) prothioconazole in an amount ranging from 50 to 500 g/ha; and
(ii) kasugamycin in an amount ranging from 10 to 300 g/ha.

In an embodiment the present invention provides a fungicidal combination for controlling rice blast diseases in rice crop, the fungicidal combination comprising:
(i) prothioconazole in an amount ranging from 50 to 500 g/ha; and
(ii) isoprothiolane in an amount ranging from 10 to 300 g/ha.

In an embodiment, the combinations of the present disclosure comprise at least a third additional fungicide or an herbicide or an insecticide.

In an embodiment, the combinations of the present disclosure comprise at least an additional fungicide.

In an embodiment, the systemic fungicide may be a single fungicide or a combination of one or more systemic fungicides.

In an embodiment, the systemic fungicide is a combination of at least two fungicides.

In an embodiment, the systemic fungicides in the fungicidal combinations is selected from nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inducers, fungicides with unknown modes of action, fungicide with no classification, or biologicals with multiple mode of action.

In a preferred embodiment, the present invention provides a fungicidal combination for controlling rice blast diseases in rice crop, the combination comprising:
(i) a triazole fungicide comprising prothioconazole,
(ii) a second fungicide comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof; and
(iii) a third fungicide comprising a multi-site fungicide.

In an embodiment, the third fungicide comprising a multi-site fungicide having contact activity is selected from inorganic compounds, dithiocarbamates, phthalimides, chloronitriles, sulfamides, bis-guanidines, triazines, quinones, quinoxalines, maleimides and thiocarbamates.

In an embodiment, the multi-site fungicide comprises copper and its salts, sulphur, amobam ferbam, mancozeb, maneb, metiram, propineb, thiram, zinc, thiazole, zineb, ziram, captan, captafol, folpet, chlorothalonil, dichlofluanid, tolylfluanid, guazatine, iminoctadine, anilazine, dithianon, dithianon, fluoroimide, and methasulfocarb.

In an embodiment, the copper salt is selected from the group comprising copper sulphate, dibasic copper sulphate, tribasic copper sulphate and copper oxychloride.

The actives of the combination of the present invention maybe applied simultaneously as a tank mix or may be applied sequentially or as a formulation. The application may be made to the soil before emergence of the plants, either at the pre-planting or post-planting stage. The application may be made as a foliar spray at different timings during crop development, with either one or two applications early or late post-emergence. More preferably, the combination of the present invention is applied to a plant propagation material.

In some embodiments, the combinations according to the present disclosure are used to treat plant propagation materials.

In some embodiments, the combinations according to the present disclosure are used to treat seeds, a type of plant propagation materials.

The combinations of present disclosure used for plant propagation materials treatment are efficacious in protecting the materials and/or the plant originating from them during target fungi's life cycle in which it causes injury to the seed or plant.

In an embodiment, the combinations for use in the control of leaf blast and neck blast in rice plants comprise prothioconazole and another fungicide. The present combinations have effective disease control as compared to the untreated in treatment of rice blast diseases.

The examples represented herein demonstrate the efficacy of combinations comprising prothioconazole and another fungicide for controlling fungal diseases in rice caused by Pyricularia oryzae, particularly leaf blast and neck blast.

Further the combinations of the present invention showed no phytotoxicity on the crop.

The combinations of the present invention as described herein may be formulated in the form of a composition.

In an embodiment, the present invention provides a composition comprising a combination as described hereinabove in any one of the aspects or embodiments, and at least one agrochemically acceptable excipient.

In an embodiment, the present invention provides a fungicide composition for effective control of rice blast diseases comprising:
(i) a demethylation inhibitor fungicide;
(ii) at least another fungicide comprising a succinate dehydrogenase inhibitor fungicide, a quinone outside inhibitors fungicide, a quinone inside Inhibitor fungicide, an inorganic compound, a 4-quinolyl acetate fungicide, hexopyranosyl antibiotic, dithiolane fungicide, dithiocarbamate fungicide; and
(iii) at least one agrochemically acceptable excipient.

In a preferred embodiment, the demethylation inhibitor fungicide is preferably a triazole fungicide,

In an embodiment the present invention provides a fungicide composition for controlling rice blast diseases, the composition comprising:
(i) a triazole fungicide;
(ii) at least one fungicide selected from a succinate dehydrogenase inhibitor fungicide or a Quinone outside Inhibitor (QoI) fungicide or a Quinone inside Inhibitor (QiI) fungicide or a 4-quinolyl acetate fungicide or a hexopyranosyl antibiotic or a dithiolane fungicide or a dithiocarbamate fungicide; and
(iii) at least one agronomically acceptable excipient.

In an embodiment, the triazole fungicide is prothioconazole, 2-[2-(1-chlorocyclopropyl)-3-(2-chlorophen-yl)-2-hydroxypropyl]-2, 4-dihydro-[1,2,4-]-triazole-3-thione or salts, or esters, metabolite, or isomers or derivatives thereof.

Thus, in an embodiment the present invention provides a fungicide composition for controlling rice blast diseases, the composition comprising:
(i) prothioconazole;
(ii) at least one fungicide selected from a succinate dehydrogenase inhibitor fungicide or a Quinone outside Inhibitor (QoI) fungicide or a Quinone inside Inhibitors (QII) Inhibitor or a 4-quinolyl acetate fungicide or a hexopyranosyl antibiotic or a dithiolane fungicide or a dithiocarbamate fungicide; and
(iii) at least one agrochemically acceptable excipient.

In an embodiment prothioconazole is applied in an amount from about 100 to 500 g a.i./ha.

In an embodiment, the present invention provides a fungicide composition for controlling rice blast diseases, the composition comprising:
(i) prothioconazole;
(ii) a Quinone inside Inhibitor (QiI) fungicide; and
(iii) at least one agrochemically acceptable excipient.

In an embodiment, the present invention provides a fungicide composition for controlling rice blast diseases, the composition comprising:
(i) prothioconazole;
(ii) a strobilurin fungicide; and
(iii) at least one agrochemically acceptable excipient.

In an embodiment, the present invention provides a fungicide composition for controlling rice blast diseases comprises:
(i) prothioconazole;
(ii) azoxystrobin, and
(iii) at least one agrochemically acceptable excipient.

In an embodiment, the present invention provides a fungicide composition for controlling rice blast diseases comprises:
(i) prothioconazole;
(ii) picoxystrobin; and
(iii) at least one agrochemically acceptable excipient.

In an embodiment the present invention provides a fungicide composition for controlling rice blast diseases comprises:
(i) prothioconazole;
(ii) fluoxastrobin. and
(iii) at least one agrochemically acceptable excipient.

In an embodiment the present invention provides a fungicide composition for controlling rice blast diseases comprises:
(i) prothioconazole;
(ii) trifloxystrobin; and
(iii) at least one agrochemically acceptable excipient.

In an embodiment, the present invention provides a fungicide composition for controlling rice blast diseases comprises:
(i) prothioconazole;
(ii) kasugamycin; and
(iii) at least one agrochemically acceptable excipient.

In an embodiment the present invention provides a fungicide composition for controlling rice blast diseases comprises:
(i) prothioconazole;
(ii) tebufloquin; and
(iii) at least one agrochemically acceptable excipient.

In an embodiment the present invention provides a fungicide composition for controlling rice blast diseases comprises:
(i) prothioconazole;
(ii) isoprothiolane; and
(iii) at least one agrochemically acceptable excipient.

In an embodiment the present invention provides a fungicide composition for controlling rice blast diseases comprises:
(i) prothioconazole;
(ii) an inorganic compound; and
(iii) at least one agrochemically acceptable excipient.

In an embodiment the present invention provides a fungicide composition for controlling rice blast diseases comprises:
(i) prothioconazole;
(ii) a copper salt; and
(iii) at least one agrochemically acceptable excipient.

In an embodiment the present invention provides a fungicide composition for controlling rice blast diseases comprises:
(i) prothioconazole;
(ii) sulphur; and
(iii) at least one agrochemically acceptable excipient.

In an embodiment, prothioconazole is applied in an agrochemically efficacious amount.

In an embodiment, the compositions may typically be produced by mixing the actives in the composition with an inert carrier and adding surfactants and other adjuvants and carriers as needed and formulated into solid, or liquid formulations, including but not limited to wettable powders, water dispersible granules (WDG), dusts, Soluble (liquid) concentrates, suspension concentrates (SC), oil dispersions (OD), oil in water emulsion, water in oil emulsion, emulsifiable concentrates, capsule suspensions, ZC formulations or other known formulation types.

In an embodiment prothioconazole is used as 30% w/v OD formulation.

In an embodiment, the present invention employs prothioconazole and azoxystrobin as a 40% w/v suspension concentrate formulation.

In an embodiment, the present invention employs prothioconazole and sulphur as a 60% to 70% w/v suspension concentrate formulation.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide and the like. The liquid carrier include, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water and the like.

Typically, the combinations/compositions of the present invention are useful for controlling phytopatogenic fungi Pyricularia oryzae in rice. Preferably the present invention is provided to prevent and control rice blast disease, mainly the present invention is provided to control rice leaf blast and/or rice neck blast by applying the present combinations/compositions comprising prothioconazole.

In an embodiment, the present invention provides use of a fungicidal combination comprising: a demethylation inhibitor fungicide, and at least one fungicide for controlling rice blast diseases, particularly caused by Magnaporthe grisea.

In an embodiment, the present invention provides use of a fungicidal combination comprising: a triazole fungicide, and at least one fungicide for controlling rice blast diseases, particularly caused by Magnaporthe grisea.

In an embodiment, the present invention provides use of a fungicidal combination comprising: a triazole fungicide, and at least one fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof; for controlling rice blast diseases, particularly caused by Magnaporthe grisea.

In an embodiment, the present invention provides use of a fungicidal combination comprising: a triazole fungicide, and a quinone outside inhibitor (QoI) fungicide comprising a strobilurin fungicide for controlling rice blast diseases, particularly caused by Magnaporthe grisea.

In an embodiment, the present invention provides use of a fungicidal combination comprising: Prothioconazole and at least one fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof; for controlling rice blast diseases, particularly caused by Magnaporthe grisea.

In an embodiment, the present invention provides use of a fungicidal combination comprising prothioconazole and azoxystrobin for controlling rice blast diseases, particularly caused by Magnaporthe grisea.

In an embodiment, the present invention provides use of a fungicidal combination comprising prothioconazole and picoxystrobin for controlling rice blast diseases, particularly caused by Magnaporthe grisea.

In an embodiment, the present invention provides use of a fungicidal combination comprising: prothioconazole and fluoxastrobin for controlling rice blast diseases, particularly caused by Magnaporthe grisea.

In an embodiment, the present invention provides use of a fungicidal combination comprising: prothioconazole and trifloxystrobin for controlling rice blast diseases, particularly caused by Magnaporthe grisea.

In an embodiment, the present invention provides use of a fungicidal combination comprising: prothioconazole and isoprothiolane for controlling rice blast diseases, particularly caused by Magnaporthe grisea.

In an embodiment, the present invention provides use of a fungicidal combination comprising: prothioconazole and tebufloquin for controlling rice blast diseases, particularly caused by Magnaporthe grisea.

In an embodiment, the present invention provides use of a fungicidal combination comprising: prothioconazole and kasugamycin for controlling rice blast diseases, particularly caused by Magnaporthe grisea.

In an embodiment, the present invention provides use of a fungicidal combination comprising: prothioconazole and an inorganic compound for controlling rice blast diseases, particularly caused by Magnaporthe grisea.

In an embodiment, the present invention provides use of a fungicidal combination comprising: prothioconazole and sulphur for controlling rice blast diseases, particularly caused by Magnaporthe grisea.

In an embodiment, the present invention provides use of a fungicidal combination for controlling rice blast diseases comprising applying a combination comprising:
(i) a demethylation inhibitor fungicide, and
(ii) at least one fungicide;
   wherein the demethylation inhibitor fungicide and the second fungicide are in a ratio ranging from 1:15 to 15:1.

In an embodiment, the present invention provides use of a fungicidal combination for controlling rice blast diseases comprising applying a combination comprising:
(i) a triazole fungicide, and
(ii) at least one fungicide;
   wherein the triazole fungicide and the second fungicide are in a ratio ranging from 1:15 to 15:1.

In an embodiment, the present invention provides use of a fungicidal combination for controlling rice blast diseases comprising applying a combination comprising:
(i) a triazole fungicide, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides use of a fungicidal combination for controlling rice blast diseases comprising applying a combination comprising:
(i) prothioconazole, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides use of a fungicidal combination for controlling rice blast diseases comprising applying a combination comprising:
(i) a triazole fungicide, and
(ii) at least a Quinone outside inhibitor (QoI) fungicide;
   wherein the triazole fungicide and the Quinone outside inhibitor (QoI) fungicide are in a ratio ranging from 1:15 to 15:1.

In an embodiment, the present invention provides use of a fungicidal combination for controlling rice blast diseases comprising applying a combination comprising:
(i) prothioconazole, and
(ii) at least a Quinone outside inhibitor (QoI) fungicide;
   wherein the triazole fungicide and the Quinone outside inhibitor (QoI) fungicide are in a ratio ranging from 1:15 to 15:1.

In an embodiment, the present invention provides use of a fungicidal combination for controlling rice blast diseases comprising applying a combination comprising:
(i) prothioconazole; and
(ii) at least one strobilurin fungicide;
   wherein prothioconazole and the strobilurin fungicide are in a ratio ranging from 1:15 to 15:1.

In an embodiment, the present invention provides use of a fungicidal combination for controlling rice blast diseases comprising applying a combination comprising:
(i) prothioconazole; and
(ii) azoxystrobin;
   wherein prothioconazole and azoxystrobin are in a ratio ranging from 1:15 to 15:1.

In an embodiment, the present invention provides use of a fungicidal combination for controlling rice blast diseases comprising applying a combination comprising:
(i) prothioconazole; and
(ii) picoxystrobin;
   wherein prothioconazole and picoxystrobin are in a ratio ranging from 1:15 to 15:1.

In an embodiment, the present invention provides use of a fungicidal combination for controlling rice blast diseases comprising applying a combination comprising:
(i) prothioconazole; and
(ii) trifloxystrobin;
   wherein prothioconazole and trifloxystrobin are in a ratio ranging from 1:15 to 15:1.

In an embodiment, the present invention provides use of a fungicidal combination for controlling rice blast diseases comprising applying a combination comprising:
(i) prothioconazole; and
(ii) fluoxastrobin;
   wherein prothioconazole and fluoxastrobin are in a ratio ranging from 1:15 to 15:1.

In an embodiment, the present invention provides use of a fungicidal combination for controlling rice blast diseases comprising applying a combination comprising:
(i) prothioconazole; and
(ii) tebufloquin;
   wherein prothioconazole and tebufloquin are in a ratio ranging from 1:15 to 15:1.

In an embodiment, the present invention provides use of a fungicidal combination for controlling rice blast diseases comprising applying a combination comprising:
(i) prothioconazole; and
(ii) kasugamycin;
   wherein prothioconazole and kasugamycin are in a ratio ranging from 1:15 to 15:1.

In an embodiment, the present invention provides use of a fungicidal combination for controlling rice blast diseases comprising applying a combination comprising:
(i) prothioconazole; and
(ii) isoprothiolane;
   wherein prothioconazole and isoprothiolane are in a ratio ranging from 1:15 to 15:1.

In an embodiment, the present invention provides use of a fungicidal combination for controlling rice blast diseases comprising applying a combination comprising:
(i) prothioconazole; and
(ii) sulphur;
   wherein prothioconazole and isoprothiolane are in a ratio ranging from 1:15 to 15:1.

In an embodiment, the present invention provides use of a fungicidal combination for controlling rice blast diseases comprising applying a combination comprising:
(i) a demethylation inhibitor fungicide in an amount ranging from 50 to 500 g/ha; and
(ii) at least one fungicide in an amount ranging from 10 to 300 g/ha.

In an embodiment, the present invention provides use of a fungicidal combination for controlling rice blast diseases comprising applying a combination comprising:
(i) a triazole fungicide in an amount ranging from 50 to 500 g/ha; and
(ii) at least one fungicide in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) at least one fungicide in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) at least one strobilurin fungicide in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) azoxystrobin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) picoxystrobin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) trifloxystrobin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) fluoxastrobin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) tebufloquin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) kasugamycin in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) isoprothiolane in an amount ranging from 10 to 300 g/ha.

In an embodiment, the present invention provides use of a fungicidal combination for controlling rice blast diseases comprising applying a combination comprising:
(i) prothioconazole in an amount ranging from 50 to 500 g/ha; and
(ii) sulphur in an amount ranging from 10 to 300 g/ha.

In one preferred embodiment, the present invention provides use of compositions/combinations comprising a fungicidally effective amount of prothioconazole and another fungicide for controlling rice leaf blast as demonstrated in the examples.

In one preferred embodiment, the present invention provides use of compositions/combinations comprising a fungicidally effective amount of prothioconazole and another fungicide for controlling rice neck blast as demonstrated in the examples.

In an embodiment, the present invention provides use of a fungicidal composition comprising: a triazole fungicide, at least one fungicide selected from the group comprising a quinone outside inhibitor (QoI) fungicide, a succinate dehydrogenase inhibitor (SDHI) fungicide, a quinone inside inhibitor (QiI) fungicide, a 4-quinolyl acetate fungicide, a hexopyranosyl antibiotic fungicide, and a dithiolane fungicide or combinations thereof, and an agriculturally acceptable excipient; for controlling rice blast diseases, particularly caused by Magnaporthe grisea.

In an embodiment, the present invention provides use of a fungicidal composition comprising: a triazole fungicide, aquinone outside inhibitor (QoI) fungicide comprising a strobilurin fungicide and an agriculturally acceptable excipient; for controlling rice blast diseases, particularly caused by Magnaporthe grisea.

In an embodiment, the present invention provides use of a fungicidal composition comprising prothioconazole, azoxystrobin and an agriculturally acceptable excipient for controlling rice blast diseases, particularly caused by Magnaporthe grisea.

In an embodiment, the present invention provides use of a fungicidal composition comprising prothioconazole, picoxystrobin and an agriculturally acceptable excipient for controlling rice blast diseases, particularly caused by Magnaporthe grisea.

In an embodiment, the present invention provides use of a fungicidal composition comprising: prothioconazole, fluoxastrobin and an agriculturally acceptable excipient for controlling rice blast diseases, particularly caused by Magnaporthe grisea.

In an embodiment, the present invention provides use of a fungicidal composition comprising: Prothioconazole, trifloxystrobin and an agriculturally acceptable excipient for controlling rice blast diseases, particularly caused by Magnaporthe grisea.

In an embodiment, the present invention provides use of a fungicidal composition comprising: prothioconazole, isoprothiolane and an agriculturally acceptable excipient for controlling rice blast diseases, particularly caused by Magnaporthe grisea.

In an embodiment, the present invention provides use of a fungicidal composition comprising: prothioconazole, tebufloquin and an agriculturally acceptable excipient for controlling rice blast diseases, particularly caused by Magnaporthe grisea.

In an embodiment, the present invention provides use of a fungicidal composition comprising: prothioconazole, kasugamycin and an agriculturally acceptable excipient for controlling rice blast diseases, particularly caused by Magnaporthe grisea.

In an embodiment, the present invention provides use of a fungicidal composition comprising: prothioconazole, sulphur and an agriculturally acceptable excipient for controlling rice blast diseases, particularly caused by Magnaporthe grisea.

The present invention further relates to a method for partial or complete curative control of the disease, condition, symptom or adverse effect associated with the incidence of rice blast caused by Magnaporthe grisea.

Typically, the present invention provides a method for preventing or controlling phytopathogenic fungi in rice, said method comprising applying the present combinations/compositions to a rice plant, plant part or a plant propagation material or to a locus thereof in a fungicidally effective amount to the target disease.

The present invention thus provides a method for effective control of rice blast diseases, particularly rice leaf blast and rice neck blast by applying a tank mix of the combinations disclosed herein or compositions comprising prothioconazole combinations to a rice plant, plant part or a plant propagation material or to a locus thereof.

In an embodiment, the method for controlling rice blast diseases comprises applying to a plant or plant part or plant propagation material or a locus thereof, the present fungicidal combination comprising a) a demethylation Inhibitor fungicide and b) at least one fungicide selected from a succinate dehydrogenase inhibitor fungicide or a Quinone outside Inhibitor fungicide or a Quinone inside Inhibitors fungicide, a 4-quinolyl acetate fungicide, a hexopyranosyl antibiotic fungicide, and a dithiolane fungicide or combinations thereof.

The preferred demethylation inhibitor fungicide is a triazole fungicide.

The preferred demethylation Inhibitor fungicide is prothioconazole.

In an embodiment, the present method for controlling Pyricularia oryzae in rice, comprises applying to a rice plant, plant part or a plant propagation material or to a locus thereof, a fungicidally effective amount of a combination/composition comprising prothioconazole and at least one fungicide selected from a succinate dehydrogenase inhibitor fungicide or a Quinone outside Inhibitors fungicide, or a Quinone inside Inhibitor fungicide, a 4-quinolyl acetate fungicide, a hexopyranosyl antibiotic fungicide, and a dithiolane fungicide or combinations thereof; as described herein.

In an embodiment, the present method provides control of rice blast particularly rice leaf blast or rice neck blast by applying present combinations comprising prothioconazole to the plants.

For use according to the present method, the compositions comprising combination of prothioconazole as described herein generally comprise between 0.01 and 95%, preferably between 0.1 and 90%, most preferably between 0.5 and 50%, by weight of active substance.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

In an embodiment, the present invention provides a method for controlling phytopathogenic fungi causing rice blast disease, said method comprising applying to a rice plant, plant part or a plant propagation material or to a locus thereof a fungicidal combination comprising:
(i) a demethylation inhibitor fungicide, and
(ii) at least one fungicide;
   wherein the demethylation inhibitor fungicide and the second fungicide are in a ratio ranging from 1:15 to 15:1.

In an embodiment, the present invention provides a method for controlling phytopathogenic fungi causing rice blast disease, said method comprising applying to a rice plant, plant part or a plant propagation material or to a locus thereof a fungicidal combination comprising:
(i) a triazole fungicide, and
(ii) at least one fungicide;
   wherein the triazole fungicide and the second fungicide are in a ratio ranging from 1:15 to 15:1.

In an embodiment, the present invention provides a method for controlling phytopathogenic fungi causing rice blast disease, said method comprising applying to a rice plant, plant part or a plant propagation material or to a locus thereof a fungicidal combination comprising:
(i) a triazole fungicide, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, a 4-quinolyl acetate fungicide, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides a method for controlling phytopathogenic fungi causing rice blast disease, said method comprising applying to a rice plant, plant part or a plant propagation material or to a locus thereof a fungicidal combination comprising:
(i) prothioconazole, and
(ii) a second fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof;
   wherein prothioconazole and the second fungicide are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof a fungicidal combination comprising:
(i) a triazole fungicide, and
(ii) at least a Quinone outside inhibitor (QoI) fungicide;
   wherein the triazole fungicide and the Quinone outside inhibitor (QoI) fungicide are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof a fungicidal combination comprising:
(i) prothioconazole, and
(ii) at least a Quinone outside inhibitor (QoI) fungicide;
   wherein the triazole fungicide and the Quinone outside inhibitor (QoI) fungicide are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) at least one strobilurin fungicide;
   wherein prothioconazole and the strobilurin fungicide are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) azoxystrobin;
   wherein prothioconazole and azoxystrobin are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) picoxystrobin;
   wherein prothioconazole and picoxystrobin are in a ratio ranging from 1:15 to 15:1.

In an embodiment, the present invention provides a method for controlling phytopathogenic fungi causing rice blast diseases, said method comprising applying a fungicidal combination comprising:
(i) prothioconazole; and
(ii) trifloxystrobin;
   wherein prothioconazole and trifloxystrobin are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) fluoxastrobin;
   wherein prothioconazole and fluoxastrobin are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) tebufloquin;
   wherein prothioconazole and tebufloquin are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) kasugamycin;
   wherein prothioconazole and kasugamycin are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) isoprothiolane;
   wherein prothioconazole and isoprothiolane are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) an inorganic compound;
   wherein prothioconazole and isoprothiolane are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) sulphur;
   wherein prothioconazole and isoprothiolane are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) a copper salt;
   wherein prothioconazole and isoprothiolane are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole; and
(ii) a tribasic copper sulphate;
   wherein prothioconazole and isoprothiolane are in a ratio ranging from 1:15 to 15:1.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) a demethylation inhibitor fungicide in an amount ranging from 50 to 500 g/ha; and
(ii) at least one fungicide in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) a triazole fungicide in an amount ranging from 50 to 500 g/ha; and
(ii) at least one fungicide in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) at least one fungicide in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) at least one strobilurin fungicide in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) azoxystrobin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) picoxystrobin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) trifloxystrobin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) fluoxastrobin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) tebufloquin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) kasugamycin in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) isoprothiolane in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) an inorganic compound in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) sulphur in an amount ranging from 10 to 300 g/ha.

In an embodiment, the present invention provides a method for controlling phytopathogenic fungi causing rice blast diseases, said method comprising applying to a rice plant, plant part or a plant propagation material or to a locus thereof, a fungicidal combination comprising:
(i) prothioconazole in an amount ranging from 50 to 500 g/ha; and
(ii) a copper salt in an amount ranging from 10 to 300 g/ha.

In some embodiment, the present combinations and compositions can be used in the form of tank mix formulation or a pre-mix formulation. The active substance concentrations in the ready-to-use or pre-mix or tank mix formulation can be varied within relatively wide ranges.

Also, the application can be carried out both before and after the infection of the plants.

In an embodiment, the active compounds/constituents of the composition may be tank mixed and sprayed at the locus of the infection or may alternatively be mixed with surfactants and then sprayed.

In an embodiment, the constituents of the composition may be used for foliar application, ground or applications to plant propagation material.

In an embodiment, the formulations of prothioconazole may be applied to the affected plant in an amount from about 0.5 L/Ha to about 5.0 L/Ha, preferably from about 1.0 L/Ha to about 2.0 L/Ha, more preferably about 1.0 L/Ha to about 1.5 L/Ha.

In an embodiment, the present invention provides a method for controlling phytopathogenic fungi causing rice blast diseases, said method comprising applying to a rice plant, plant part or a plant propagation material or to a locus thereof, a fungicidal combination comprising: (iii) a triazole fungicide in an amount ranging from 50 to 500 g/ha; and (iv) at least one fungicide in an amount ranging from 10 to 300 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and at least one fungicide in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and at least one fungicide in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and a strobilurin fungicide in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and a strobilurin fungicide in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and picoxystrobin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and picoxystrobin in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and azoxystrobin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and azoxystrobin in in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and trifloxystrobin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and trifloxystrobin in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and fluoxastrobin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and fluoxastrobin in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and tebufloquin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and tebufloquin in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and kasugamycin in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and kasugamycin in an amount ranging from 200 to 2500 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and isoprothiolane in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and isoprothiolane in an amount ranging from 200 to 2500 g/ha.

In an embodiment, the present invention provides a method for controlling phytopathogenic fungi causing rice blast diseases, the method comprising applying to a rice plant, plant part or a plant propagation material or to a locus thereof, a fungicidal composition comprising prothioconazole and sulphur in an amount ranging from 100 to 3000 g/ha.

In a preferred embodiment, the present invention provides a method for controlling phytopathogenic fungi causing rice blast diseases, the method comprising applying to a rice plant, plant part or a plant propagation material or to a locus thereof, a fungicidal composition comprising prothioconazole and sulphur in an amount ranging from 200 to 2500 g/ha.

The composition comprising combination of prothioconazole as described herein can be used as such by means of spraying, atomizing, dusting, spreading, brushing, immersing or pouring.

The compositions of this invention may further comprise fertilizers such as ammonium nitrate, urea, potash, and superphosphate, phytotoxicants and plant growth regulators and safeners.

These may be used sequentially or in combination with the above described compositions, if appropriate also added only immediately prior to use (tank mix). For example, the plant(s) may be sprayed with a composition of this invention either before or after being treated with the fertilizers.

In some embodiment, the present compositions may be applied in any desired sequence, or in any combination, consecutively or simultaneously. The application rate of the total amount of the fungicidally active composition comprising combination of prothioconazole may be any suitable rate to treat the target plants.

In an embodiment, the method of the present invention provides effective controlling of fungal pathogens such that, the method can be applied at pre or post emergence of the fungal diseases, thereby providing resistance management and complete control of the fungal pathogens.

Moreover, the present combinations show no phytotoxicity on the plants.

The invention also provides a kit comprising prothioconazole combinations for the control of Pyricularia oryzae on rice and instructions for use. The present kit comprising prothioconazole combinations as described herein is very useful of controlling rice blast particularly rice leaf blast and rice neck blast. The instructions for use typically comprise instructions for the application of the present prothioconazole combinations to the locus.

In an embodiment, the kit comprises:
i) a first component, wherein the first component comprises prothioconazole;
ii) a second component, wherein the second component comprises the second fungicide selected from the group comprising a quinone outside inhibitor (QoI) fungicide, a succinate dehydrogenase inhibitor (SDHI) fungicide, a quinone inside inhibitor (QiI) fungicide, a 4-quinolyl acetate fungicide, a hexopyranosyl antibiotic fungicide, and a dithiolane fungicide or combinations thereof;

Typically, the kit comprises:
i) a first component, wherein the first component comprises prothioconazole;
ii) a second component, wherein the second component comprises the second fungicide;
iii) a third component comprising at least one agrochemically acceptable excipient, diluent, adjuvant and/or safener; and optionally further comprises:
iv) instructions for use.

Typically, the instructions for use comprise instructions directing a user to admix the components of the kit. Usually, the instructions for use comprise instructions directing a user to admix the components of the kit before application of the components of the kit to the locus. Often, the components of the kit are packaged separately. However, the invention is not limited to kits in which the components are packaged separately. For example, the first component and the second component may be packaged together or formulated together.

The fungicidal combination/composition of the present invention is highly safe to the crop plants and capable of controlling target fungi in rice fields and were surprisingly found to be synergistic towards the control of target fungi in rice fields. Thus, present invention provides best solution to the pain point of rice growers.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and following examples, but by all embodiments and methods within the scope and spirit of the invention.

### EXAMPLES

### Example 1: Efficacy of Prothioconazole and Azoxystrobin Combination on Control of Rice Leaf Blast Disease

Trials were conducted to determine the efficacy of the prothioconazole and azoxystrobin combination against leaf blast on rice crop by foliar application. The application effect of the said combination of fungicides according to the present invention on leaf blast fungi was demonstrated by the following field trial. The evaluation for the % control of the pathogenic fungi in rice crop was carried out using a scale from 0 to 100%, compared to the untreated control rice crop. The application was performed in a plot size of 12 m² (3m×4m).

In the following experiments, the fungicidal activity of the prothioconazole and azoxystrobin combination was assessed. In this trial, time T was the application time, wherein A-0 days, i.e. at the time of the first application, B is designated as the second application at 7 days after application ‘A’ (i.e. 7 DAA) and C is designated as the third application at 14 days after application A (i.e. 14 DAA) and so on. Accordingly, the observations for % control in the rice crop were made at 7 DAA, 14 DAA, 21 DAA and at 28 DAA. The final values reported were the average of four (4) repetitions.

TABLE 1(a)
Treatments

| | | | Rate | Ap. |
|---|---|---|---|---|
| No. | Treatment | Formulation | (gai/ha) | code |
| 1. | Untreated check | Not treated | — | — |
| 2. | Azoxystrobin + Prothioconazole | 400 g/L SC | 400 | ABC |
| 3. | Tricyclazole | 75% WP | 300 | ABC |

TABLE 1(b)
Evaluation of % control of leaf blast fungi

| | | Rate | % Efficacy | | | |
|---|---|---|---|---|---|---|
| No. | Treatment | (gai/ha) | 7 DAA | 14 DAA | 21 DAA | 28 DAA |
| 1. | Untreated check | — | 0.0 | 0.0 | 0.0 | 0.0 |
| 2. | Azoxystrobin + | 400 | 96.80 | 95.80 | 96.60 | 98.30 |
| | Prothioconazole | | | | | |
| 3. | Tricyclazole | 300 | 26.20 | 17.10 | 13.10 | 11.60 |

As can be observed from the data set out in table 1(b), the combination comprising prothioconazole and azoxystrobin exhibited a significantly greater fungicidal efficacy in the control of leaf blast fungi as compared to the reference product (tricyclazole).

### Example 2: Efficacy of Prothioconazole and Kasugamycin Combination on Control of Rice Leaf Blast Disease

Trials were conducted to determine the efficacy of prothioconazole and kasugamycin combination against leaf blast on rice. The application effect of the said combination of fungicides according to the present invention on leaf blast fungi was demonstrated by the following field trial. The trial also includes Tricyclazole treatments. The application effect of the said combination of fungicides according to the present invention on leaf blast fungi —Magnaporthe grisea was demonstrated by the following field trial. Evaluation for the % control of the pathogenic leaf blast fungi was carried out using a scale from 0 to 100%, compared to the untreated control plants. The application was performed in a plot size of 12 m² (3m×4m).

In the following experiments, the fungicidal activity of the prothioconazole and kasugamycin combination was assessed. In this trial, time T was the application time, wherein A-0 days, i.e. at the time of the first application, B is designated as the second application at 7 days after application ‘A’ (i.e. 7 DAA), C is designated as the third application at 14 days after application A (i.e. 14 DAA) and so on. Accordingly, the observations for % control in the rice crop were made at 7 DAA, 14 DAA, 21 DAA and at 28 DAA.

TABLE 2(a)

| | | Formulation | Rate | Ap. |
|---|---|---|---|---|
| No. | Treatment | Conc. | (gai/ha) | code |
| 1. | Untreated check | — | — | — |
| 2. | Prothioconazole + | 250 g/L + 20 g/L | 120 + 30 | ABC |
| | Kasugamycin | | | |
| 3. | Tricyclazole | 75% WP | 300 | ABC |

TABLE 2(b)
Evaluation of % control of leaf blast fungi (Magnaporthe grisea)

| | | Rate | % Efficacy | | | |
|---|---|---|---|---|---|---|
| No. | Treatment | (gai/ha) | 7 DAA | 13 DAA | 21 DAA | 28 DAA |
| 1. | Untreated check | — | — | — | — | — |
| 2. | Prothioconazole + | 120 + | 96.10 | 94.60 | 93.80 | 98.20 |
| | Kasugamycin | 30 | | | | |
| 3. | Tricyclazole | 300 | 26.20 | 17.10 | 13.10 | 11.60 |

As can be seen from the data set out in above table, the combinations comprising prothioconazole and kasugamycin exhibited a significantly greater efficacy in the control of leaf blast fungi as compared to the reference product (tricyclazole).

### Example 3: Efficacy of Prothioconazole and QoI Combination Against Rice Neck Blast Fungi

Trials were conducted to determine the efficacy of the prothioconazole and Kasugamycin combination against neck blast on rice. The application effect of the said combination of fungicides according to the present invention on rice neck blast was demonstrated by the following field trial.

TABLE 3(a)
Treatments

| | | Rate |
|---|---|---|
| No. | Treatment | (gai/ha) |
| 1. | Untreated check | — |
| 2. | Prothioconazole | 120 |
| 3. | Prothioconazole + Azoxystrobin | 120 + 280 |
| 4. | Prothioconazole + Picoxystrobin | 120 + 67 |
| 5. | Prothioconazole + Trifloxystrobin | 120 + 100 |

TABLE 3(b)
Treatments

| | | Rate | |
|---|---|---|---|
| No. | Treatment | (gai/ha) | % Control |
| 1. | Untreated check | — | 0 |
| 2. | Prothioconazole | 120 | 41.49 |
| 3. | Prothioconazole + Azoxystrobin | 120 + 280 | 73.92 |
| 4. | Prothioconazole + Picoxystrobin | 120 + 67 | 71.51 |
| 5. | Prothioconazole + Trifloxystrobin | 120 + 100 | 61.12 |

The above results show that fungicide combinations comprising prothioconazole were very effective for controlling neck blast on rice plants and its effect is better than prothioconazole alone treatment.

### Example 4: Efficacy of Prothioconazole Combinations Against Rice Neck Blast Fungi

Trials were conducted to determine the efficacy of the prothioconazole combinations against neck blast fungi (Magnaporthe grisea) on rice.

TABLE 4 (a)
Treatments

| No. | Treatment | Rate (gai/ha) |
|---|---|---|
| 1. | Untreated check | — |
| 2. | Prothioconazole + Kasugamycin | 120 + 30 |
| 3. | Prothioconazole + Tebuconazole | 120 + 120 |

TABLE 4(b)
Control efficacy

| | | Rate | |
|---|---|---|---|
| No. | Treatment | (gai/ha) | % Control |
| 1. | Untreated check | — | 0 |
| 2. | Prothioconazole + Kasugamycin | 120 + 30 | 53.89 |
| 3. | Prothioconazole + Tebuconazole | 120 + 120 | 57.54 |

From the above results, the fungicide combinations comprising prothioconazole provide excellent control efficiency against neck blast on rice plants as compared to the untreated check.

### Example 5: Synergistic Control of Neck Blast in Rice

Trials were conducted to determine the synergistic control of the prothioconazole combinations against neck blast on rice. The application effect of the disclosed fungicidal combinations against rice neck blast according to the present invention was demonstrated by the following field trial.

A frequently used method for improving the use profile of an agrochemical is the combination of an active compound with one or more other active compounds which contribute to the desired additional properties. However, when two or more active compounds are applied in combination, it is not uncommon for phenomena of physical and biological incompatibility to occur, for example insufficient stability of a joint formulation, decomposition of an active compound or antagonism of the active compounds. What is desired are, in contrast, active compound combinations having a favorable activity profile, high stability and, if possible, synergistically enhanced activity, thus permitting the application rate to be reduced, compared with the individual application of the active compounds to be combined. Chemical mixtures can have an antagonistic effect when mixed, where the results are less than expected when the chemicals are combined. There can also be an additive effect, where the resultant mixture gives results expected from the sum of its components. Finally, there can be a synergistic effect where the results are greater than expected. A synergistic result is rare and typically only observed in results from high concentrations. In the heavily regulated agrochemical industry, high concentrations are not desirable in the environment. Therefore, when a synergistic effect is achieved at low doses, the resultant mixture is indeed a rare and unexpected finding.

A synergistic effect of an agrochemical is always present when the anti-phytopathogenic activity of the active compound combinations exceeds the total of the activities of the active compounds when applied individually. The expected activity for a given combination of two active compounds can be calculated according to S. R. Colby (“Calculating Synergistic and Antagonistic Responses of Herbicide Combinations”, Weeds 15, (1967), 20-22).

### Colby Calculation:

This effectiveness of all treatments as measured by percent reduction in the target phytopathogen growth, was also evaluated according to Colby's equation as below.

If,
X is the percent inhibition of growth by prothioconazole (A) at an application rate,
Y is the percent inhibition of growth by another fungicide selected from strobilurin fungicides, a dithiolane fungicide at an application rate, and
E is the expected growth as a percent of control with prothioconazole and the second fungicide when applying the active compounds, A and B at application rates
Then,

$${Colby}^{′} s equation E = X + Y - XY / 100$$

If the actual/observed anti-phytopathogenic efficacy of prothioconazole and the second fungicide against Pyricularia oryzae growth exceeds the calculated value, then the activity of the combination is super additive, i.e. a synergistic effect exists. In this case, the efficacy which was actually observed must be greater than the value for the expected efficacy (E) calculated from the abovementioned formula.

TABLE 5(a)
% control of Pyricularia oryzae causing neck blast using the
combination of prothioconazole and a strobilurin fungicide

| | | Observed | | | | |
|---|---|---|---|---|---|---|
| | | efficacy of | | Observed | | |
| | | demethylation | | efficacy of | Observed | Expected |
| | | inhibitor | | stobilurin | efficacy of | efficacy of |
| Sr. | Treatment | fungicide | Treatment | fungicide | combination | combination |
| No. | (g a.i./ha) | (%) | (g a.i./ha) | (%) | (%) | (%) |
| 1. | Prothioconazole | 49 | Picoxystrobin | 42 | 74 | 70.42 |
| | 120 g a.i./ha | | 67.8 g a.i./ha | | | |
| 2. | Prothioconazole | 49 | Trifloxystrobin | 60 | 83 | 79.6 |
| | 120 g a.i./ha | | 100 g a.i./ha | | | |

The present combination consisting of prothioconazole and picoxystrobin, prothioconazole and trifloxystrobin in its application is synergistic and provides effective control of the Pyricularia oryzae fungi.

TABLE 5(b)
% control of Pyricularia oryzae causing neck blast using the
combination of prothioconazole and a dithiolane fungicide

| | | Observed | | | | |
|---|---|---|---|---|---|---|
| | | efficacy of | | | | |
| | | demethylation | | Observed | Observed | Expected |
| | | inhibitor | | efficacy of | efficacy of | efficacy of |
| Sr. | Treatment | fungicide | Treatment | isoprothiolane | combination | combination |
| No. | (g a.i./ha) | (%) | (g a.i./ha) | (%) | (%) | (%) |
| 3. | Prothioconazole | 49 | Isoprothiolane | 48 | 80 | 73.48 |
| | 120 g a.i./ha | | 250 g a.i./ha | | | |

The present combination consisting of prothioconazole and isoprothiolane in its application is synergistic and provides effective control of the Pyricularia oryzae fungi as seen in Table 4(b).

### Example 5: Efficacy of the Fungicidal Composition Comprising Prothioconazole and Sulphur on Leaf Blast in Rice

Trials were conducted to determine the efficacy of the prothioconazole and Kasugamycin combination against leaf blast on rice. The application effect of the said combination of fungicides according to the present invention on rice neck blast was demonstrated by the following field trial. In the following experiments, the fungicidal activity of the composition consisting of prothioconazole and sulphur combination were assessed. Treatments 2, 3 and 4 in Table 6 use suspension concentrate compositions comprising prothioconazole and sulphur at 675 g/L, 676 g/L and 677 g/L, respectively.

In this trial, time T was the application time, wherein A-0 days, i.e. at the time of the first application, B is designated as the second application at 7 days after application ‘A’ (i.e. 7 DAA) and C is designated as the third application at 14 days after application A (i.e. 14 DAA) and so on. Accordingly, the observations for % control in the rice crop were made at 7 DAA, 14 DAA, 21 DAA and at 28 DAA. The final values reported were the average of four (4) repetitions.

TABLE 6

| | | | Efficacy (%) | | | |
|---|---|---|---|---|---|---|
| | | Rate | 7 | 14 DAA | 21 DAA | 28 DAA |
| No. | Treatment name | (gai/ha) | DAA | (7 DAB) | (7 DAC) | (14 DAC) |
| 1 | Untreated Check | | 0.00 | 0.00 | 0.00 | 0.00 |
| 2 | Prothioconazole + | 1690 | 95.00 | 94.00 | 94.20 | 96.70 |
| | Sulphur | | | | | |
| 3 | Prothioconazole + | 2030 | 95.10 | 94.30 | 91.80 | 97.20 |
| | Sulphur | | | | | |
| 4 | Prothioconazole + | 2360 | 94.60 | 96.10 | 95.70 | 98.10 |
| | Sulphur | | | | | |

The present composition consisting of prothioconazole and sulphur in its application provides effective control of the Pyricularia oryzae fungi as seen in Table 6.

We claim:

1. A fungicidal combination for controlling blast diseases in rice comprising:
(i) a demethylation inhibitor fungicide; and
(ii) a fungicide(s) selected from demethylation inhibitors (DMI's), quinone outside inhibitors (QOI's), succinate dehydrogenase inhibitors (SDHI's), quinone inside inhibitors (QII's), a 4-quinolyl acetate fungicide, an inorganic compound, a hexopyranosyl antibiotic fungicide, or a dithiolane fungicide or combinations thereof.

2. The fungicide combination as claimed in claim 1, wherein the (i) demethylation inhibitor fungicide is a triazole fungicide.

3. The fungicide combination as claimed in claim 2, wherein the triazole fungicide is selected from the group comprising azaconazole, bromuconazole, cyproconazole, diclobutrazol, difenoconazole, diniconazole, diniconazole-M, epoxiconazole, etaconazole, fenbuconazole, fluconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, thiabendazole, triadimefon, triadimenol, triticonazole, uniconazole and uniconazole-P, their salts, or esters, or isomers or derivatives thereof or combinations thereof.

4. The fungicide combination as claimed in claim 2, wherein the triazole fungicide is prothioconazole.

5. The fungicide combination as claimed in claim 1, wherein the quinone outside inhibitor is selected from strobilurin fungicides comprising azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone or pyribencarb.

6. The fungicide combination as claimed in claim 1, wherein the succinate dehydrogenase inhibitor (SDHI) is selected from the group comprising benzovindiflupyr, bixafen, fluxapyroxad, furametpyr, isopyrazam, penflufen, penthiopyrad, sedaxane, boscalid, thifluzamide, carboxin, oxycarboxin, fenfuram, fluopyram, isofetamid, benodanil, flutolanil or mepronil.

7. The fungicide combination as claimed in claim 1, wherein the dithiocarbamate fungicide is selected from the group comprising amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb or zineb.

8. The fungicide combination as claimed in claim 1, wherein the QII is selected from the group comprising cyazofamid, amisulbrom, fenpicoxamid and florylpicoxamid.

9. The fungicide combination as claimed in claim 1, wherein the inorganic compound is a sulphur salt or a copper salt comprising copper sulphate, copper oxychloride, tribasic copper sulphate.

10. The fungicide combination as claimed in claim 1, wherein the 4-quinolyl acetate fungicide is tebufloquin.

11. The fungicide combination as claimed in claim 1, wherein the hexopyranosyl antibiotic fungicide is kasugamycin.

12. The fungicide combination as claimed in claim 1, wherein the dithiolane fungicide is isoprothiolane.

13. The fungicidal combination as claimed in claim 1, said combination comprising:
(i) prothioconazole; and
(ii) at least one strobilurin fungicide.

14. The fungicidal combination as claimed in claim 1, said combination comprising:
(i) prothioconazole; and
(ii) azoxystrobin.

15. The fungicidal combination as claimed in claim 1, said combination comprising:
(i) prothioconazole; and
(ii) picoxystrobin.

16. The fungicidal combination as claimed in claim 1, said combination comprising:
(i) prothioconazole; and
(ii) trifloxystrobin.

17. The fungicidal combination as claimed in claim 1, said combination comprising:
(i) prothioconazole; and
(ii) fluoxastrobin.

18. The fungicidal combination as claimed in claim 1, said combination comprising:
(i) prothioconazole; and
(ii) tebufloquin.

19. The fungicidal combination as claimed in claim 1, said combination comprising:
(i) prothioconazole; and
(ii) kasugamycin.

20. The fungicidal combination as claimed in claim 1, said combination comprising:
(i) prothioconazole; and
(ii) isoprothiolane.

21. The fungicidal combination as claimed in claim 1, said combination comprising:
(i) prothioconazole; and
(ii) sulphur.

22. The fungicidal combination as claimed in claim 1, said combination comprising a demethylation inhibitor fungicide and one more fungicide(s) in a ratio ranging from 1:15 to 15:1.

23. The fungicidal combination as claimed in claim 1, said combination comprising a demethylation inhibitor fungicide and one more fungicide(s) in a ratio ranging from 1:10 to 10:1.

24. The fungicidal combination as claimed in claim 1, wherein the blast disease in rice is caused by Magnaporthe grisea.

25. The fungicidal combination as claimed in claim 1, the combination further comprising a multi-site fungicide or a systemic fungicide.

26. A fungicidal composition for controlling blast diseases in rice comprising:
(i) a demethylation inhibitor fungicide comprising a triazole fungicide,
(ii) one or more fungicides selected from the group comprising demethylation inhibitors (DMI's), dithiocarbamates, quinone outside inhibitors (QOI's), succinate dehydrogenase inhibitors (SDHI's), quinone inside inhibitors (QII's), an inorganic compound, a 4-quinolyl acetate fungicide, a hexopyranosyl antibiotic fungicide, and a dithiolane fungicide or combinations thereof, and
(iii) one or more agrochemically acceptable excipients.

27. The fungicidal composition as claimed in claim 26, wherein the composition comprises:
(i) prothioconazole,
(ii) a quinone outside inhibitor comprising strobilurin fungicides, and
(iii) one or more agrochemically acceptable excipients.

28. The fungicidal composition as claimed in claim 26, wherein the composition comprises:
(i) prothioconazole,
(ii) at least one strobilurin fungicide comprising azoxystrobin, picoxystrobin, pyraoxystrobin, pyraclostrobin, trifloxystrobin, and
(iii) one or more agrochemically acceptable excipients.

29. The fungicidal composition as claimed in claim 26, wherein the composition comprises:
(i) prothioconazole,
(ii) sulphur, and
(iii) one or more agrochemically acceptable excipients.

30. The fungicidal composition as claimed in claim 26, wherein the composition comprises:
(i) prothioconazole,
(ii) isoprothiolane, and
(iii) one or more agrochemically acceptable excipients.

31. The fungicidal composition as claimed in claim 26, wherein the composition comprises:
(i) prothioconazole,
(ii) tebufloquin, and
(iii) one or more agrochemically acceptable excipients.

32. The fungicidal composition as claimed in claim 26, wherein the composition comprises:
(i) prothioconazole,
(ii) kasugamycin, and
(iii) one or more agrochemically acceptable excipients.

33. A method for controlling rice blast diseases comprising applying to a rice plant a plant part or a plant propagation material or a locus thereof, a fungicidal combination comprising:
(i) a demethylation inhibitor fungicide, and
(ii) at least one fungicide comprising a succinate dehydrogenase inhibitor fungicide, a quinone outside Inhibitor fungicide, a quinone inside inhibitor fungicide, an inorganic compound, a 4-quinolyl acetate fungicide, a hexopyranosyl antibiotic fungicide, and a dithiolane fungicide or combinations thereof.

34. The method as claimed in claim 33, the method comprising applying to a locus of a rice plant a fungicidal combination comprising:
(i) a triazole fungicide, and
(ii) at least one fungicide selected from a succinate dehydrogenase inhibitor fungicide, a quinone outside Inhibitor fungicide, an inorganic compound, a quinone inside inhibitor fungicide, a 4-quinolyl acetate fungicide, a hexopyranosyl antibiotic fungicide, and a dithiolane fungicide or combinations thereof.

35. The method as claimed in claim 33, the method comprising applying to a locus of a rice plant a fungicidal combination comprising:
(i) prothioconazole, and
(ii) at least one fungicide selected from a succinate dehydrogenase inhibitor fungicide, a quinone outside Inhibitor fungicide, a quinone inside inhibitor fungicide, a 4-quinolyl acetate fungicide, a hexopyranosyl antibiotic fungicide, and a dithiolane fungicide or combinations thereof.

36. The method as claimed in claim 33, the method comprising applying to a locus of a rice plant a fungicidal combination comprising:
(i) prothioconazole in an amount ranging from 50 to 500 g/ha; and, and
(ii) at least one fungicide selected from a succinate dehydrogenase inhibitor fungicide, a quinone outside Inhibitor fungicide, a quinone inside inhibitor fungicide, a 4-quinolyl acetate fungicide, a hexopyranosyl antibiotic fungicide, and a dithiolane fungicide or combinations thereof in an amount ranging from 10 to 300 g/ha.

37. The method as claimed in claim 33, the method comprising applying to a locus of a rice plant a fungicidal combination comprising:
(i) prothioconazole in an amount ranging from 50 to 500 g/ha; and, and
(ii) a quinone outside inhibitor is selected from strobilurin fungicides comprising azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, famoxadone, fluoxastrobin, fenamidone or pyribencarb in an amount ranging from 10 to 300 g/ha.

38. The method as claimed in claim 33, the method comprising applying to a locus of a rice plant a fungicidal combination comprising:
(i) prothioconazole in an amount ranging from 50 to 500 g/ha; and, and
(ii) a dithiolane fungicide comprising isoprothiolane in an amount ranging from 10 to 300 g/ha.

39. The method as claimed in claim 33, the method comprising applying to a locus of a rice plant a fungicidal combination comprising:
(i) prothioconazole in an amount ranging from 50 to 500 g/ha; and, and
(ii) a hexopyranosyl antibiotic fungicide comprising kasugamycin in an amount ranging from 10 to 300 g/ha.

40. The method as claimed in claim 33, the method comprising applying to a locus of a rice plant a fungicidal combination comprising:
(i) prothioconazole in an amount ranging from 50 to 500 g/ha; and, and
(iii) a 4-quinolyl acetate fungicide comprising tebufloquin in an amount ranging from 10 to 300 g/ha.

41. A method for controlling rice blast diseases comprising applying to a rice plant or a plant part or a plant propagation material or a locus thereof, a fungicidal composition as claimed in claim 26, the method comprising applying the fungicidal composition in an amount ranging from 100 to 3000 g/ha.

42. The method as claimed in claim 41, the method comprising applying the fungicidal composition in an amount ranging from 200 to 2500 g/ha.

43. Use of a fungicidal combination comprising prothioconazole and at least one fungicide selected from the group comprising a quinone outside inhibitor (QoI) fungicide, a succinate dehydrogenase inhibitor (SDHI) fungicide, a quinone inside inhibitor (QiI) fungicide, an inorganic compound, a 4-quinolyl acetate fungicide, a hexopyranosyl antibiotic fungicide, and a dithiolane fungicide or combinations thereof; for controlling rice blast diseases, particularly caused by Magnaporthe grisea.
